(19) United States
(12) Patent Application Publication
(10) Pub. No.: US 2017/0120734 A1
(43) Pub. Date: May 4, 2017

(54) APPARATUS FOR RAISING PANEL TRUCK DOORS

(71) Applicant: ON THE MOVE, INC., Boerne, TX (US)

(72) Inventor: Maurice M. Westerdale, Dearborn, MI (US)

(21) Appl. No.: 15/284,185

(22) Filed: Oct. 3, 2016

Related U.S. Application Data
(60) Provisional application No. 62/236,575, filed on Oct. 2, 2015.

(51) Int. Cl. B60J 5/14; E06B 9/70; E05F 15/40; B60J 5/10; E05F 15/603

(52) U.S. Cl. CPC B60J 5/14; B60J 5/108; E05F 15/603; E05F 15/40; E06B 9/70; E05Y 2201/434; E05Y 2400/44; E05Y 2900/516; E06B 2009/6836

(57) ABSTRACT

The apparatus operates roll up doors used on commercial vehicles by employing dual powered opener/closer motors. The motors are mounted along the door tracks and there is no motor unit that must be mounted in the cargo space of the truck in the matter of a garage door opener the current invention is more suited for commercial vehicle use. The motors are synchronized in order to avoid having the door jam, or otherwise damaging the door, due to one side of the door raising or lowering more quickly than the other. The motors may have integrated rechargeable batteries so that the motors and door move along the tracks with wires.

This application is based upon and claims priority from U.S. Provisional application Ser. No. 62/236,575, which is incorporated herein by reference.

### BACKGROUND OF THE INVENTION

Field of the Invention

Applicants' invention relates to a device for remotely operating a motor-assisted roll-up commercial truck door.

Background Information

There have been many efforts to make the vehicle doors of commercial trucks and vehicles more efficient to operate and safer for workers. To date, these attempts have significantly failed. It can be very difficult to manually raise and lower a commercial door. Even if the user is able to raise and lower the door, doing so can be a repetitive activity that can cause injury over time. As a result, numerous back injuries and other injuries occur each year due to slip and falls, and other accidents, while users attempt to open and close commercial doors. These accidents and injuries can result in numerous “Workers' Compensation” claims being filed each year.

It is quite common for garage doors to be open and closed by electric motors. Smaller garage doors may be made using a single panel that tilts up and back across the garage ceiling. Larger doors are usually made using a multiplicity of jointed panels that roll up on tracks across the garage ceiling. An even larger doors, the jointed panels may roll up into a roll above the doorway. The operating mechanism is a spring-loaded or counterbalanced mechanism where the motor is online with the center of the door approximately level with the top of the doorway. Thus, the door is pulled up from the center which maintains the balance of the doorway.

### SUMMARY OF THE INVENTION

Commercial trucks and vehicles often have doors similar to a garage door in that they are made of a multiplicity of panels that roll up along the door track. The present invention is an apparatus to operate roll up doors used on commercial vehicles by employing dual powered opener/closer actuators. Because the actuators are mounted along the door tracks and there is no motor unit that must be mounted in the cargo space of the truck in the matter of a garage door opener the current invention is more suited for commercial vehicle use.

In a first embodiment, two rechargeable electric motors are used. The first motor is in operative communication with a first roller which is engaged with a first track on a first side of the door and doorway. The second motor is in operative communication with a second roller which is engaged with a second track on the second side of the door and doorway. The motors turn their respective rollers that engage the door tracks and thus the motors and rollers are in operative communication with the door. When the motors are positively activated they cause the rollers to turn moving the door upward along its track. When the motors are negatively activated they cause the rollers to turn moving the door downward along its track. The first and second motors are synchronized in order to avoid having the door jam, or otherwise damaging the door, due to one side of the door raising or lowering more quickly than the other. Thus, the first and second motors are synchronized so that they move at the same speed in order to keep the bottom of the door relatively horizontal. A locking mechanism may be used to secure the doors. In order for the doors to be opened, the locking mechanism must be unlocked. Therefore, when the locking mechanism recognizes a start-up cycle the locking mechanism unlocks, or when the motors are activated the locking mechanism is also activated unlocking the door, allowing the door to move upwardly. At the top of the door tracks, a portion of the actuator, the door, or the roller comes in contact with a switch that acts as an up stop. It is anticipated that the actuators will be activated by a driver or other user remotely—either in the cab of the commercial vehicle or otherwise away from the actuators.

It is anticipated that the actuator 100 may be installed as described herein as a commercial vehicle is manufactured, however it does not preclude retrofitting existing commercial vehicles.

### BRIEF DESCRIPTION OF THE DRAWINGS

FIG. 1 is a cutaway, perspective view of the rear of a commercial vehicle with the present invention installed.

FIG. 2 is a top view of an actuator attached to a portion of a commercial vehicle door.

FIG. 3A is a top view of a locking mechanism for use with the present invention.

FIG. 3B is a perspective view of a locking mechanism for use with the present invention.

FIG. 4 is a side view of a stop sensor for use with the present invention.

### DETAILED DESCRIPTION OF THE PREFERRED EMBODIMENT

Referring to the figures, the figures are labeled as follows:

| | |
|---|---|
| 2 | Door |
| 4 | Cover |
| 6 | Base |
| 8 | Truck |
| 10 | Motor |
| 12 | Door Frame |
| 14 | Floor |
| 16 | Top |
| 18 | Rechargeable Battery |
| 20 | Drive Wheel |
| 22 | Door Track |
| 24 | Roller |
| 26 | Axle |
| 28 | Axle Connector |
| 30 | Contacts |
| 32 | Locking Mechanism |
| 33 | Solenoid |
| 34 | Stop Pin |
| 35 | Compression Spring |
| 36 | Pin Tip |
| 38 | Locking Apperture |
| 40 | Pin |
| 42 | Rocker |
| 44 | Rocker Support Member |
| 50 | Spring |
| 52 | Spring Base |
| 54 | Motor Extension Member |
| 56 | Stabilizer |
| 60 | Up Stop |
| 61 | Up Stop Switch |
| 62 | Release |
| 64 | Kill Switch |
| 66 | Down Stop |
| 100 | Actuator |

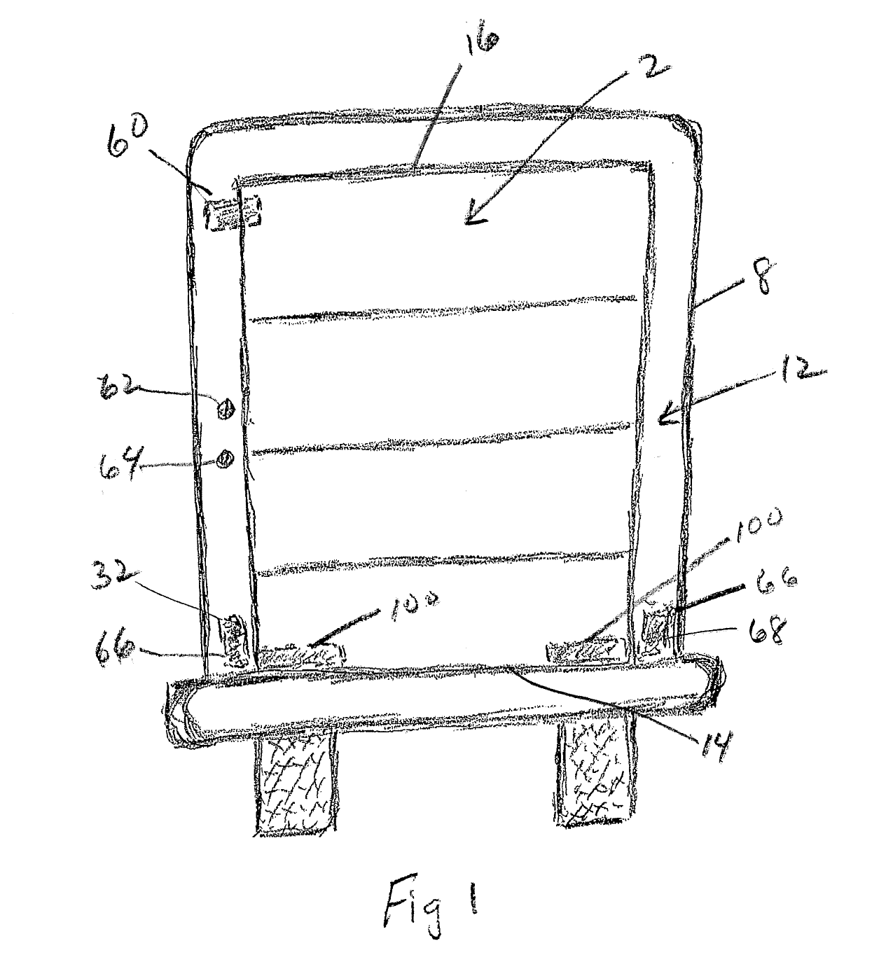

FIG. 1 illustrates a partial cutaway of the rear of a truck 8. Bordering the perimeter of a doorway is a truck door frame 12. Filling the door frame 12 is a door 2. The door 2 reaches from the truck bottom 14 to the truck top 16. The storage area inside the commercial vehicle is generally in the shape of a cuboid (also called a rectangular cuboid, an orthotope, or a hyperrectangle). On the inside of the door frame 12 is a door track 22 that runs upwardly along the frame 12 from near the floor 14 to near the top 16. Shown in cutaway style, are actuators 100 that are mounted near the bottom and on the interior side of the door 2. When motors 10, which are part of the actuators 100, are he along the track 22. A locking mechanism 32 is positioned along the track 22 such that when the door 2 is in the down position, the locking mechanism 32 is slightly above the roller 24. The locking mechanism 32 unlocks when it recognizes the start of the up cycle, or when the door 2 begins to move upwardly. As the door 2 moves upwardly and the roller 24 nears the top 16 it will come into contact with an up stop 60. It is anticipated that other portions of the actuator 100 or drive wheel 20 might also contact the up stop 60 instead. When the up stop 60 is contacted it activates an up stop switch 61 that is in electronic communication with the actuator 100 and causes the motor 10 to deactivate, stopping the door 2 in an open position with the bottom of the door 2 near the top 16 of the truck 8. When the door 2 is closed the up stop 60 and locking mechanism 32 act in reverse—when the close cycle starts, or when the door 2 starts moving down, the up stop causes the actuator 100 and motor 10 to activate in reverse lowering the door 2. After the leading edge of the door 2 passes the locking mechanism 32, the locking mechanism 32 locks the door 2 in the closed, or down, position.

It is anticipated that the locking mechanism (solenoid) 32 will be integrated with the charging contacts 30 and located at the bottom of the track 22.

The use of a mechanical up stop 60 eliminates the switch 61 if a remote control up button is depressed through the up cycle. The user would recognize when the door is in its maximum opposition and would release the up button (not shown) on the remote control assembly. The downward cycle would work in the same manner with the user either manually stopping the downward cycle of the door or using a down stop (not shown) to effectuate the door ending its downward cycle.

Because it is anticipated that there may be times in which a user will want to immediately stop the movement of the door 2, a kill switch 64 may be mounted in a convenient place on the commercial vehicle 8, such as on the frame 12. The kill switch 64 is in electronic communication with the actuator 100 and motor 10. When the kill switch 64 is activated it causes the motor 10 to deactivate stopping the door to at the then present position. If the user is required to depress an up or down button on a remote control assembly throughout the entire up or down cycle, then a kill switch would not be necessary.

It is anticipated that a user may be inside the interior of the truck 8 storage space when the door 12 is closed. Therefore a release switch 62 may be installed in the interior of the truck 8 storage space. The release switch 62 is in electronic communication with the actuators 100. When the release switch 62 is activated the motors 10 are positively activated raising the door 2 to its open position and allowing the trapped user to escape.

It is anticipated that there are times when power would not be available for the motor 10 in which case the actuator 100 will allow the door to be moved manually.

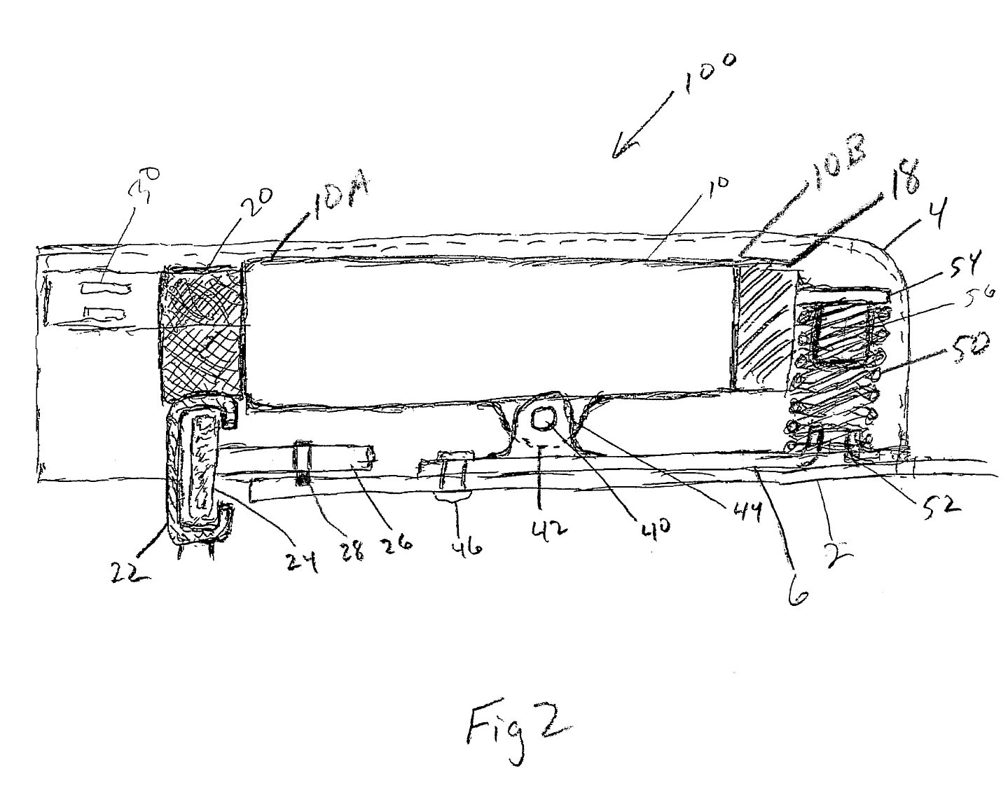

FIG. 2. shows the actuator 100 assembly attached to the interior of the door 2 from a top view. The actuator 100 assembly is comprised of a motor 10, a pressure spring apparatus, a drive wheel 20, and contacts 30. It may also include a cover 4. The actuator 100 assembly is attached to the door 2 near the side of the door where the roller 24 is attached to the door 2 via its axle 26 and axle connector 28. The roller 24 sits within a door track 22 and the roller 24 rotates about the axle 26.

It is anticipated that the actuator mechanism 100 may be further comprised of a motor (such as a 12 V motor) with or without an integrated battery pack (similar to a conventional battery powered hand tool) that delivers enough energy to raise and lower the door.

Near the midpoint of the length of the motor 10 and drive wheel 20 assembly, a rocker 42 is attached. Opposite the rocker 42 is a rocker support member 44 that is attached to the interior side of the door 2. The rocker 42 and the rocker support member 44 are connected using a pin 40. The rocker 42 and rocker support member 44 have apertures through which the pin 40 extends. The rocker 42 and rocker support member 44 are designed such that when the pin 40 is inserted through the apertures of the rocker 42 and rocker support member 44, the rocker 42 can rotate about the center axis of the pin 40. Thus, the motor 10 is attached to the interior of the door 2, but the ends of the motor 10 can move inward or outward, to and from the door 2. At a first end 10a of the motor 10 a drive wheel 20 is attached via a driveshaft (not shown). The motor 10 is sized and the rocker 42 and rocker support member 44 are positioned such that the drive wheel 20 is positioned directly adjacent to the door track 22. A motor extension member 54 is attached to the second and 10b of the motor 10. The motor extension member 54 extends outwardly and parallel to the door 2. A spring 50 is positioned between the motor extension member 54 and door 2. The spring 50 is held in place by a spring base 52 that is attached to the door 2. The spring base 52 extends outwardly from the door 2. Extending inwardly toward the door 2 from, and attached to, the motor extension member 54 is a stabilizer 56. The spring 50 sits between the spring base 52 and the motor extension member 54, and has helped to be held in place by the spring base 52 and the stabilizer 56. The spring 50 exerts pressure outwardly against the door to and the motor extension member 54. This outward pressure on the second end 10b of the motor 10 in conjunction with the rotational movement of the motor about the axis of the pin 40 causes the drive wheel 20 to press against the door track 22. It is anticipated that the drive wheel 20 will be made from a substance with a relatively high coefficient of friction sufficient such that when the motor 10 is activated and the drive wheel 20 begins to turn, it will move the door upwardly or downwardly due to the drive wheel's 20 contact with the door track 22 and not tend to slip. Thus for example, the drive wheel might be made from neoprene, urethane, or other rubber-like substances.

When the motor 10 is positively activated the driveshaft (not shown) is turned, along with the drive wheel 20, in a direction that raises the door 2. When the motor 10 is negatively activated the driveshaft (not shown) is turned, along with the drive wheel 20, in a direction that lowers the door 2.

It is anticipated that the motor 10 may derive its power from a vehicle battery, in which case the motor 10 would be required to be in electrical communication with the external battery or other electrical source. If an external battery is used to power the motor 10 then wiring would need to be provided from the source to the motor 10. While this can be difficult due to the relative movement of the motor 10 up and down the door track 22, it can be done.

Alternatively, the actuator 100 may include within its assembly and onboard, rechargeable battery 18. If an onboard, rechargeable battery 18 is used, then in order to recharge the battery contacts 30 would be included in the actuator 100 assembly and attached to the motor 10 and in electrical communication with the rechargeable battery 18. It is anticipated that a vehicle electrical source such as a battery or alternator would be an electrical communication with first complementary contacts attached at the bottom of the door track 22 such that when the door 2 is lowered to its closed position the contacts 30 would connect with the first complementary contacts (not shown) so as to close a circuit between the electrical source (not shown) and the rechargeable battery 18. In this manner, the rechargeable battery 18 would be recharged while the door 2 is in the closed position and power to raise and lower the door 2 would be maintained. (FIG. 2 is not intended to be limiting as to the location of the rechargeable battery 18 in the actuator 100.) It is also anticipated that a second complementary contacts (not shown) could be installed at the top of the door track 22. Like the first complementary contacts (not shown) the second complementary contacts would be in electrical communication with the vehicle power source (not shown) and would connect with the contacts 30 such that when the door was in its open position the rechargeable battery 18 would be recharged. In order to protect the life of the vehicle power source, switches could be installed such that the rechargeable battery 18 would only be recharged at a certain time—such as when the vehicle engine (not shown) is running.

The use of wireless motors 10 avoids fixed wiring that would be chafed as the door 2 is raised and lowered. It is a major safety feature as it avoids fires that could be started from poor wiring design and use.

It is anticipated that several activation devices might be used in order to raise and lower the door 2 via the actuator 100, such as a wired switch in electrical communication with the motor 10 and located remotely from the actuator 100, or other wireless switching devices. It is also anticipated that certain actions might automatically, positively or negatively activate the motor 10 such as locking/unlocking the door, starting the vehicle engine, or putting the vehicle in gear.

In another embodiment, the actuators 100 raise and lower the door 2 using two rack and pinion tracks. The motor arbor length is the full length of the door 2 and engages the track 22 on both the right and left hand sides of the door 2 to provide synchronism and avoid jamming, or otherwise damaging, the door 2 due to one side of the door 2 raising or lowering more quickly than the other. Generally, on smaller width doors it is not necessary to employ a rack and pinion on both sides.

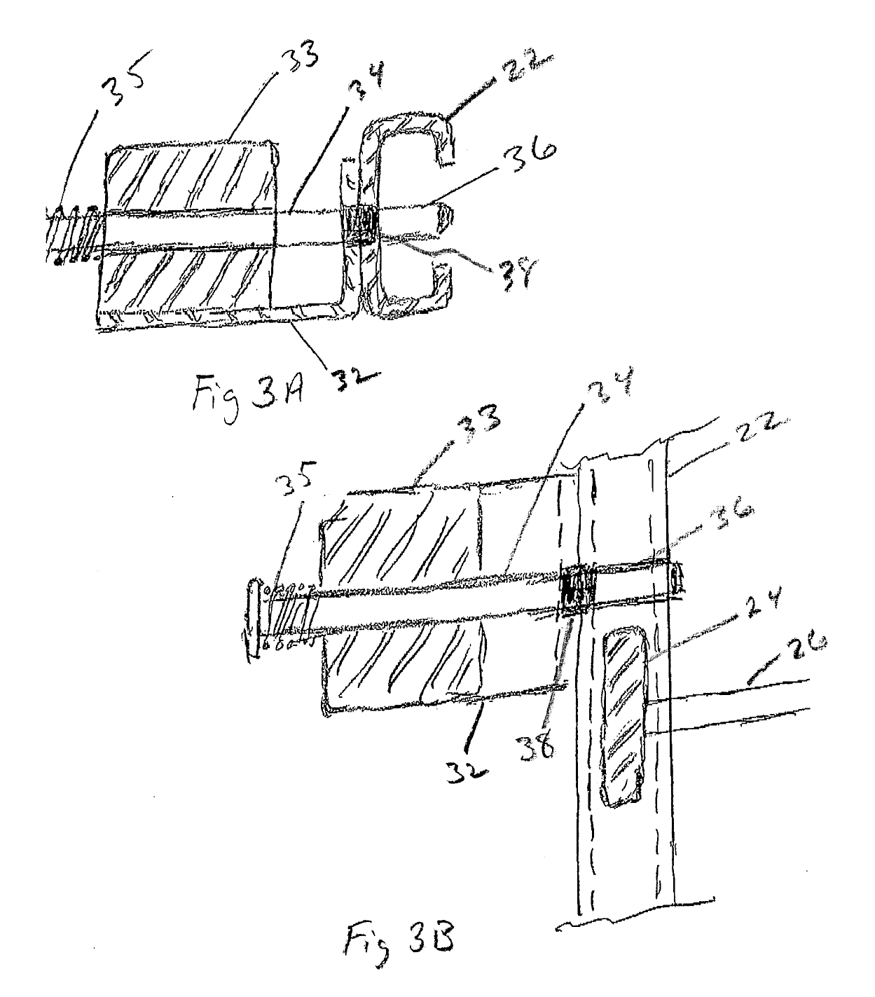

FIGS. 3A and 3B show a locking mechanism 32 that can stop the door 2 from moving along the door track 22. While the locking mechanism 32 may be placed in a position along the door track 22 that the manufacturer or user desire, is anticipated that it would be placed just above the actuator 100 when the door 2 is in its closed position. FIG. 3A is a top view of the locking mechanism 32 attached to the door track 22 the locking mechanism 32 has a solenoid 33 that moves a stop pin 34. It is anticipated that the locking mechanism 32 and solenoid 33 will be integrated with the charging contacts 30 and likely located at the bottom of the track 22. The pin 34 extends through the solenoid 33 and its pin tip 36 further extends through a locking aperture 38 and into the door track 22 such that it can block movement of the roller 24 in the door track 22. The side of the pin 34 opposite the pin tip 36 extends outwardly from the solenoid 33 and is engaged with a compression spring 35 that acts to fold the pin tip 36 out of the door track 22 through the locking aperture 38 such that the roller 24 may move through the door track 22. When the solenoid 33 is activated, the pin 34 is moved and opposition to the compression spring 35 and is inserted into the door track 22.

FIG. 3B is a perspective view of the locking mechanism 32 attached to the door track 22 with the solenoid 33 activated and the pin 34 moved in opposition to the compression spring 35 causing the pin tip 36 to extend into the door track 22 and thus block the roller 24 from moving upwardly. Thus the locking mechanism 32 provides a locking function for the door 2. Before a user can raise the door 2, the solenoid 33 must be energized in order to release the door. It is anticipated that the solenoid may be energized by either being hardwired to a power source and switch or be wirelessly switched. The locking mechanism 32 provides security for the contents of the commercial vehicle. The locking mechanism 32 can be released electrically by the remote, key, or switch. In the advent of an electrical failure the key can release a manual override on the locking mechanism 32.

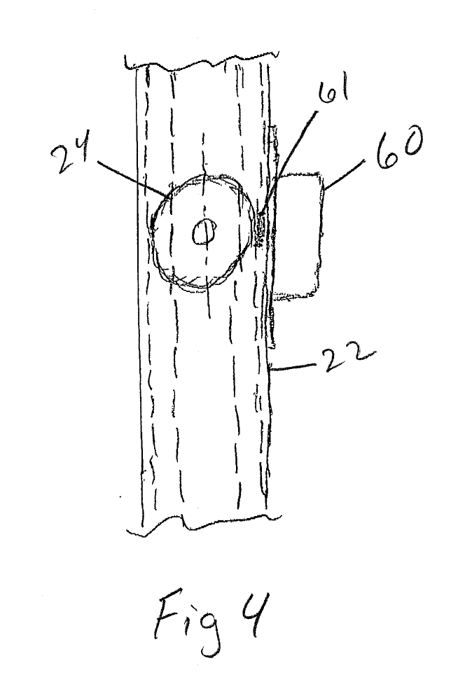

FIG. 4 illustrates a sensor that will recognize when the door 2 is in the open position and shut off the motor 10. There are many embodiments that this sensor may take. Embodiment illustrated by FIG. 4 shows a up stop switch in the track 22 that may be contacted by the roller 24 when the door 2 raises sufficiently. The up stop switch 61 would be activated by the roller 24. The up stop switch 61 is in electrical communication with an up stop 60. The up stop 60 would be in communication with the motor 10 and, when activated, would signal the motor 10 to deactivate.

Likewise other sensors (not shown) similar to the up stop 60 and up stop switch 61 could be placed so as to recognize an obstruction in the door track 22 and shut off the motor 10 when an obstruction could damage the door 2. This is also important if the motors 10 are not synchronized. Synchronizing the energy to raise and lower the door to avoid match-boxing is critical.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

I claim:

1. An apparatus for raising a panel truck door, the panel truck having a doorway and a first track on a first side of the doorframe and a second track on a second side of the doorframe, comprising:
a first motor;
a second motor;
a first roller;
a second roller;
wherein said first motor is in operative communication with said first roller and said first roller is engaged with said first track;
wherein said second motor is in operative communication with said second roller and said second roller is engaged with said second track;
wherein said first and second motors are engaged with said door;
wherein when said first motor is positively activated it causes said first roller to move up said first track;
wherein when said second motor is positively activated it causes said second roller to move up said second track;
wherein when said first motor is negatively activated it causes said first roller to move down said first track;
wherein when said second motor is negatively activated it causes said second roller to move down said second track; and
wherein said first and second motors are synchronized so that they move at the same speed in order to keep the bottom of the door relatively horizontal.

2. The apparatus of claim 1 wherein said first motor has a first battery to supply power to said first motor, said second motor has a second battery to supply power to said second motor, and wherein said first and second batteries are rechargeable.

3. The apparatus of claim 2, further comprising:
a first power lead in electrical communication with a power source on said panel truck;
wherein said first power lead is in electrical contact with said first motor when said first motor is at a set location on said first track so as to recharge said first motor;
a second power lead in electrical communication with a power source on said panel truck; and
wherein said second power lead is in electrical contact with said second motor when said second motor is at a set location on said second track so as to recharge said second motor.

4. The apparatus of claim 3, wherein said set position is the down position.

5. The apparatus of claim 1, wherein said first and second motors are activated by one of: a remote control, a key, a switch, opening said panel truck's door, or unlocking said panel truck's door.

6. The apparatus of claim 1, further comprising:
a sensor capable of detecting when said door is in the raised position and deactivating said first and second motors.

7. The apparatus of claim 1, further comprising:
a sensor capable of detecting if there is an obstruction to the movement of said door and deactivating said first and second motors.
